(19) United States
(12) Patent Application Publication
(10) Pub. No.: US 2005/0015555 A1
(43) Pub. Date: Jan. 20, 2005

(54) Method and apparatus for replacement candidate prediction and correlated prefetching

(76) Inventor: Christopher B. Wilkerson, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/621,745

(22) Filed: Jul. 16, 2003

(51) Int. Cl. G06F 12/00

(52) U.S. Cl. 711/128; 711/133

(57) ABSTRACT

A method and apparatus for determining replacement candidate cache lines, and for correlated prefetching, is disclosed. In one embodiment, a predictor determines whether a cache line that has a relative age older than a selected max-age is referenced fewer times than a threshold value. If so, then that cache line may be selected for replacement. In another embodiment, a correlating prefetcher may prefetch a cache line when it is found to be correlated to a cache line resident in a lower-order cache.

### FIELD

The present disclosure relates generally to microprocessor systems, and more specifically to microprocessor systems capable of operating with multiple levels of cache.

### BACKGROUND

In order to enhance the processing throughput of microprocessors, processors may prefetch data from a higher order cache into a lower order cache. However, sometimes prefetching may inhibit performance by causing such effects as cache pollution. Another effect may follow cache eviction of modified cache lines. The bus performance may be affected by the need to both load the new cache line and write back the modified cache line. Existing replacement algorithms such as least-recently-used and pseudo-least-recently-used may not identify which cache lines to replace in a manner that inhibits these problems.

The problems of prefetch mis-prediction may also exacerbate these problems. Improved prefetching predictors may be implemented, but current designs require inordinate amounts of circuitry and other system resources.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a schematic diagram of a cache with a max-age replacement candidate predictor, according to one embodiment.

FIG. 2 is a schematic diagram of counters within the max-age replacement candidate predictor of FIG. 1, according to one embodiment.

FIG. 3 is a schematic diagram of a correlation prefetcher using intra-set links, according to one embodiment of the present disclosure.

FIG. 4 is a schematic diagram a correlation prefetcher using age links derived from least-recently-used bits, according to one embodiment of the present disclosure.

FIG. 5 is a schematic diagram of a processor system, according to one embodiment of the present disclosure.

### DETAILED DESCRIPTION

The following description describes techniques for determining whether a cache line is a candidate for replacement, and for determining whether a cache line should be prefetched based upon its correlation with cache lines resident in a lower-order cache. In the following description, numerous specific details such as logic implementations, software module allocation, bus signaling techniques, and details of operation are set forth in order to provide a more thorough understanding of the present invention. It will be appreciated, however, by one skilled in the art that the invention may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation. The invention is disclosed in the form of a processor, such as the Pentium 4® class machine made by Intel® Corporation. However, the invention may be practiced in other forms of processors that use caches.

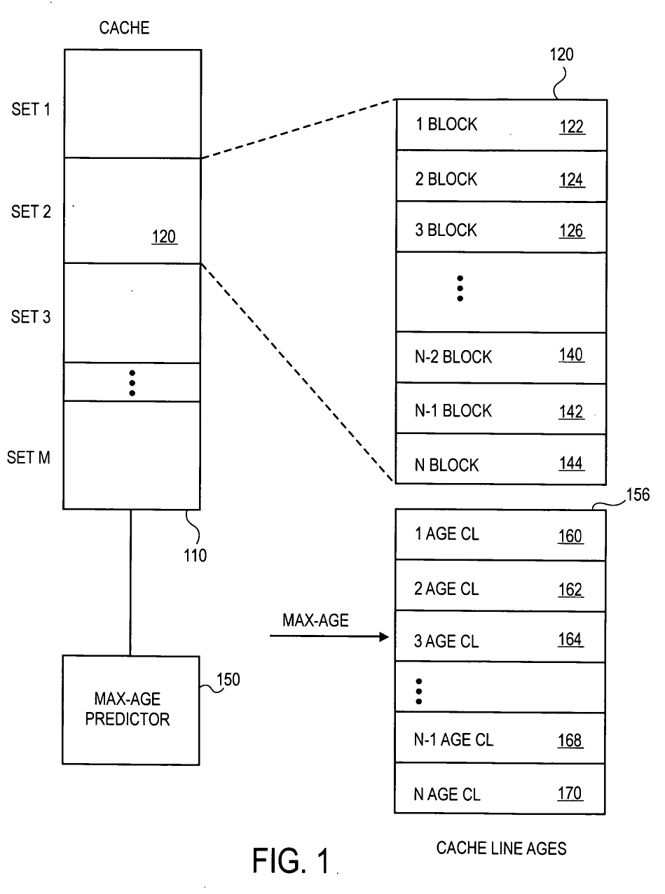

Referring now to FIG. 1, a schematic diagram of a cache with a max-age replacement candidate predictor is shown, according to one embodiment. Cache 110 is shown as a N-way set associative cache with M sets. Set 1 120 is shown expanded for discussion, but the method described may be practiced in any of the sets. Set 1 120 has N blocks 122 through 144 in which cache lines may be loaded. Each cache line that may be loaded into blocks 122 through 144 may have an associated relative age from 1 through N. The relative age may be with respect to a cache line that has just been loaded from memory (or from a higher-order cache), or with respect to a cache line that has just been referenced (read from or written to). The determination of the relative age may be accomplished using one of several well-known algorithms.

In order to more easily discuss the relative age of cache lines, FIG. 1 includes a diagram of current cache line ages, listed in order from newest age (1 age cache line 160) through oldest age (N age cache line 170). In this manner we may graphically discuss the relative ages of cache lines, as the relative ages of the cache lines in the physical blocks, block 1 122 through block N 144, may not be in any particular order and may change over time. As program execution proceeds, cache lines newly loaded in a block are listed as relative age 1. This relative age changes in time, for the most-currently referenced cache line may then be listed as having relative age 1.

In some programs' execution, the relative ages may shift freely among the N resident cache lines, and each cache line may take the relative age 1 over a relatively short period of time. In this case, few or none of the cache lines may be considered good candidates for replacement. Prefetching a new cache line into any of these cache lines would likely cause cache pollution, as the replaced cache line would probably need to be brought back into the cache. Similarly, any kind of opportunistic write-back of these cache lines may give bad performance, as the written-back cache line would probably be referenced and modified again.

However, it may be noticed that in other programs' execution, only a relatively small number of the resident cache lines may be referenced over a period of time. It may be likely that those cache lines with larger relative ages may not be referenced again. Such cache lines may be considered good candidates for replacement, as it is likely that they will not be referenced in the near future and that they will not be modified again. Therefore in one embodiment, a max-age predictor 150 may determine the likelihood that a particular cache line may be referenced while at a relative age beyond some predetermined limit of relative age. This predetermined limit of relative age may be called a max-age. If a particular cache line currently at a relative age beyond the max-age is determined to be unlikely to be referenced, then that cache line may be a good candidate for replacement or opportunistic write-back. If none of the examined cache lines is determined to be a good candidate for replacement, then the max-age predictor 150 may inhibit prefetching from occurring. This inhibition of prefetching may prevent the occurance of cache pollution.

For example, FIG. 1 shows a pointer illustrating a max-age of 3, corresponding to the cache line of relative age 3 164. The max-age of 3 may be chosen from analysis or by software simulation. In other embodiments, other values of max-age from 1 through N could be chosen. If it is determined that the cache line of relative age N−1 168 is unlikely to be referenced, as it is currently beyond the max-age value, then it may be deemed a good candidate for replacement. If, on the other hand, is determined that the cache line of relative age N−1 168 is likely to be referenced, then it may be deemed not to be a good candidate for replacement.

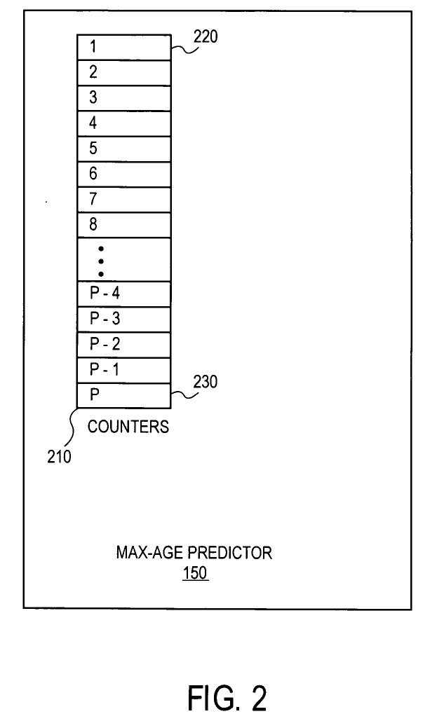

Referring now to FIG. 2, a schematic diagram of counters within the max-age replacement candidate predictor of FIG. 1 is shown, according to one embodiment. In order to make the determination of whether a particular cache line is likely to be referenced beyond a max-age value, in one embodiment a max-age predictor 150 may include a set 210 of counters 220 through 230, each associated with a particular cache line in memory. In one embodiment, the counters are saturating (i.e. they do not “roll over” when incremented at their maximum value or when decremented at their minimum value). The counter values may be compared with a predetermined prediction threshold to determine whether or not the particular cache line associated with that counter is likely to be referenced beyond a max-age value. In one embodiment, the max-age predictor 150 may decrement a counter when the associated cache line is loaded into the cache. In one embodiment, the max-age predictor 150 may increment a counter whenever the associated cache line is referenced when the relative age of that cache line is beyond the max-age value. In this manner the value of the counters may provide one measure of the associated cache lines being referenced at a relative age beyond the max-age value.

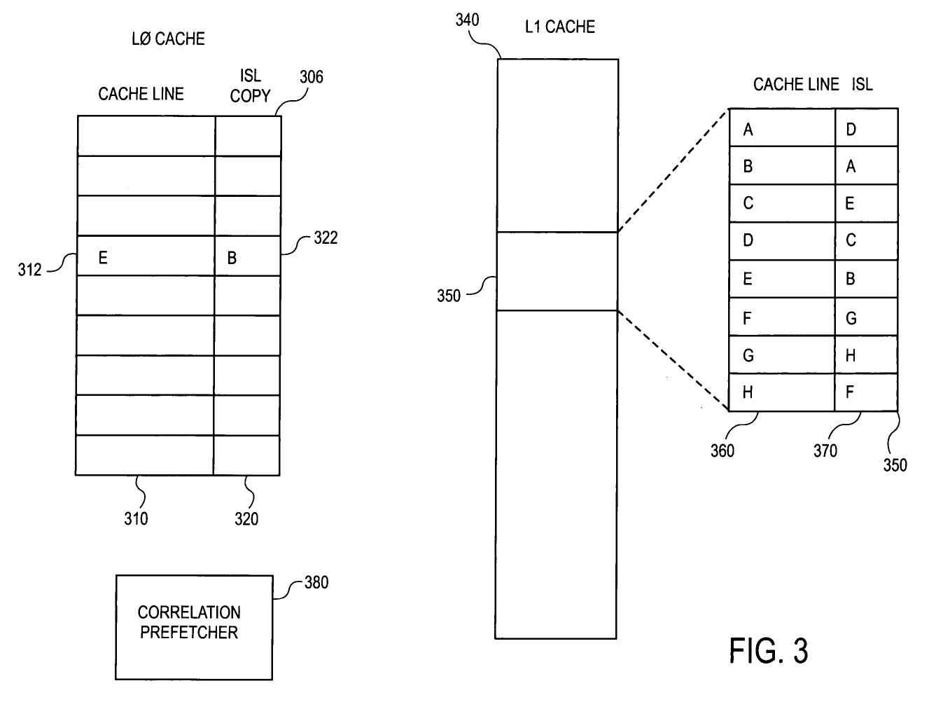

Referring now to FIG. 3, a schematic diagram of a correlation prefetcher using intra-set links is shown, according to one embodiment of the present disclosure. Generally, correlation prefetchers leverage the fact that the program may often request data addresses in a particular order that may be likely to be repeated during the program's execution. In the FIG. 3 embodiment, two caches differing by one rank order are shown: L0 cache 306 and L1 cache 340. In other embodiments, an L1 cache and an L2 cache could be used, or an L2 cache and system memory. In the FIG. 3 embodiment, L0 cache 306 is a direct-mapped cache (i.e. 1-way set associative cache) and L1 cache 340 is an 8-way set associative cache. In other embodiments, other values for the number of ways in a set associative cache may be used.

In a set associative cache, each block in memory may only be loaded into the cache in one particular set. In a direct-mapped cache, each block in memory may only be loaded into the cache in the single block. Therefore, in the example shown in FIG. 3, cache lines A through H in set 350 may only be present in L1 cache 340 in set 350, and may only be present (one at a time) in one cache line 312 within L0 cache 306. In order to efficiently prefetch cache lines from set 350 of L1 cache 340 to cache line 312 of L0 cache 306, a correlation prefetcher 380 may determine whether a particular cache line in set 350 is positively correlated with the current cache line in cache line 312. This positive correlation may be determined if the cache line in set 350 is observed to be frequently loaded subsequent to the current cache line in cache line 312. The determination may be by gathering statistics from program execution, by software simulation, or by many other means.

In the FIG. 3 embodiment, the correlation prefetcher 380 may operate by generating values for intra-set links (ISL). Each of the cache lines in set 350 may have a few additional bits attached to hold an ISL determined by a correlation prefetcher. In the 8-way set associative L1 cache 340, a set of 3-bit ISL storage locations 370 may be appended to the set of cache lines 360 comprising set 350. In other embodiments, a 16-way set associative cache may have a set of 4-bit ISL storage locations and a 4-way set associative cache may have a set of 2-bit ISL storage locations. The correlation prefetcher 380 may determine for each cache line which other cache line is correlated to follow it in residency in L0. For the FIG. 3 example, cache line C may be followed in residency by cache line E, so appended to cache line C is an ISL pointing to cache line E. Similarly cache line E may be followed in residency by cache line B, so appended to cache line E is an ISL pointing to cache line B.

In one embodiment, L0 cache 306 includes a set of 3-bit ISL copy storage locations 320 appended to the set of cache lines 310. When a cache line is fetched or prefetched from L1 cache 340, the corresponding ISL is brought along as an ISL copy. When the correlation prefetcher 380 determines that a prefetch may be performed, the correlation prefetcher 380 uses the value of the ISL copy to determine which cache line in L1 cache 340 should be prefetched. In the FIG. 3 example, cache line E 312 has associated ISL copy B 322. Therefore, cache line B resident in set 350 of L1 cache 340 would be retrieved in a prefect operation.

In some cases the ISLs may not be available. For example, if a cache miss occurs when accessing set 350 of L1 cache 340, a new cache line may be brought into set 350. The correlation prefetcher may not at that time have a value for the ISL of the newly resident cache line. In this case, it may be possible to provide a value for the ISL by providing for each set, such as set 350, a predetermined value for use as an ISL when the true ISL is yet to be determined. In one embodiment, the most-recently-used (MRU) cache line may be selected. Which cache line is the MRU cache line may already be known due to the relative age determination of the cache lines in the set.

In another embodiment, the most-frequently-used (FRQ) cache line may be selected. One manner of determining the FRQ cache line may be to associate a counter, of a small number of bits, with each cache line in L1 cache 340. In one embodiment, the number of bits may be 8 or 16. The counter may be incremented each time the cache line is referenced, and may be set to zero when a cache line is replaced. To determine the FRQ cache line of a set, the counters may be examined and the cache line with the highest counter value may be selected as the FRQ cache line. This large number of counters and logic may be burdensome to the designer. In another embodiment, a pseudo-most-frequently-used (PFRQ) cache line may be used as an ISL value. In one embodiment, the PFRQ may be determined using a 3-bit saturating counter and a R-bit tag when the cache is 2R-way. The R-bit tag may point to an initial FRQ candidate cache line in the set. Each cache hit to the set may produce the relative age of the referenced cache line, which may be compared to the relative age of the FRQ candidate cache line. If the relative age of the referenced cache line is less than the current RFQ candidate cache line, the 3-bit saturating counter may be incremented. If the relative age of the referenced cache line is more than the current RFQ candidate cache line, the 3-bit saturating counter may be unchanged. If the relative age of the referenced cache line is equal to the current RFQ candidate cache line, the 3-bit saturating counter may be decremented.

The method of prefetching discussed above in connection with FIG. 3 presumes that prefetching may be continuously permitted. In some embodiments, a replacement candidate predictor may be used to determine whether or not to permit prefetching in light of the probability of causing cache pollution. When no candidates for replacement can be found, prefetching may be inhibited. In one embodiment, the max-age replacement candidate predictor of FIGS. 1 and 2 may be used. In another embodiment, an expiration signature replacement candidate predictor may be used. The expiration signature predictor generally operates by maintaining a hash for each cache line in memory, called a historical expiration signature (HES), which may be a hash of all the program counter values of the instructions that reference that cache line during its last L0 cache residency. Each cache line currently in residence in the L0 cache may have associated another hash, called a constructed expiration signature (CES), which may be a hash of the program counter values of the instructions that have referenced that cache line thus far in its current L0 cache residency. When the CES matches the HES, the cache line may be selected for replacement.

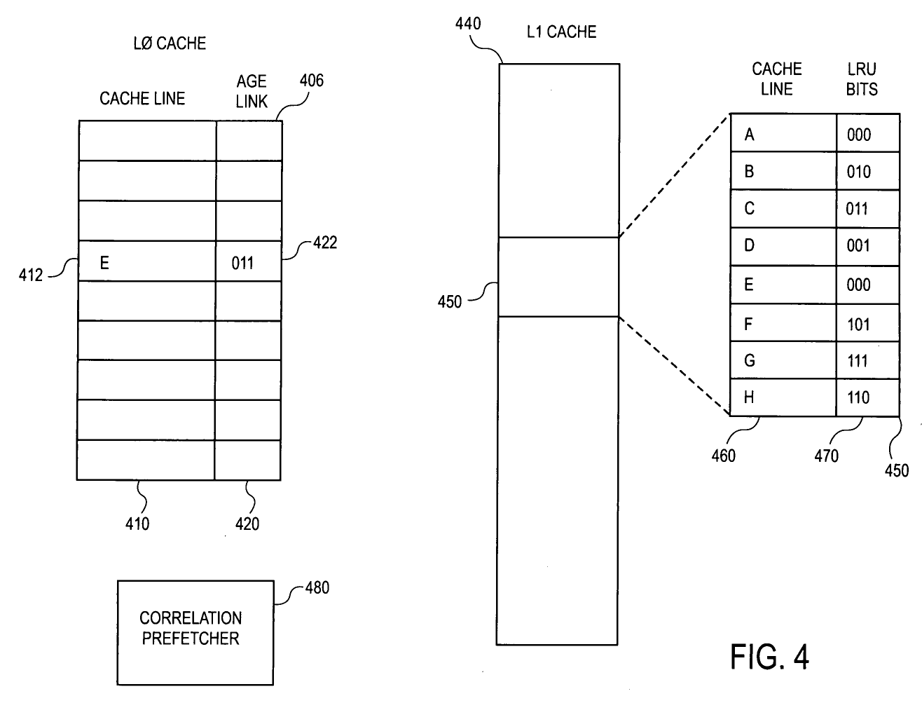

Referring now to FIG. 4, a schematic diagram a correlation prefetcher 480 using age links derived from least-recently-used (LRU) bits is shown, according to one embodiment of the present disclosure. In the FIG. 4 embodiment, L0 cache 406 and L1 cache 440 may be any of the kinds of cache discussed above in connection with FIG. 3. The true LRU bits, which may be obtained by methods well-known in the art, may provide a relative age ordering on all the blocks in a set. Consider set 450 in L1 cache 440. Set 450 includes both a set of cache lines 460 and a set of LRU bits 470 to contain LRU values. Given the relative age ordering shown in FIG. 4, E-D-B-C-A-F-H-G, it may be deduced that cache line F is correlated with and is followed by cache line A, and that cache line C is correlated with and follows cache line B. In general, a cache line with age X has a correlated successor at age X−1 or perhaps X−2.

In general, a correlated successor for a cache line may have been referenced at least once since the given cache line has been referenced. It may be inferred that the correlated successor for a cache line, of relative age N (in a K-way set associative cache) is a cache line with a relative age in the range from 1 to (N−1). To identify the correlated successor of a cache line of relative age N, as few as log₂(N−1) bits may be used. For example, using age linking, a cache line of relative age 2 may require 0 bits, a cache line of relative age 3 may require 1 bit, and a cache line of relative age 4 may require 2 bits. Age links may be constructed for the 6 most-recently-used cache lines in an encoded form using as few as 7 bits. This compares favorably with the 24 bits that may be used with the intra-set link embodiment of FIG. 3.

Table I below shows how each cache line may be associated with its correlated successor. The column labeled “age” indicates the relative age of the cache line in question. The columns labeled “A” and “B” depict a bit pattern and the relative age it indicates for the cache line's correlated successor. For example, in column A the cache line at relative age 1 (e.g. the most-recently-used cache line) is indicated as a correlated successor for the cache lines at relative ages 3, 4, 5, and 6. In column B, the cache line at relative age 3 has a correlated successor at relative age 2, the cache line at relative age 4 has a correlated successor at relative age 3, and the cache lines at relative ages 5 and 6 have a correlated successor at relative age 4.

TABLE I

| | | |
|---|---|---|
| age | A | B |

| | | |
|---|---|---|
| Age3 | (0)-Age1 | (1)-Age2 |
| Age4 | (00)-Age1 | (10)-Age3 |
| Age5 | (00)-Age1 | (11)-Age4 |
| Age6 | (000)-Age1 | (011)-Age4 |

Each time a reference is made to the L1 cache, the ages get modified. Therefore the age links require that a read-modify-write operation be performed on the bits that store the age links. When a cache line is referenced, its age may be first extracted from the LRU bits. Then the age links may be updated in two stages. In the first stage, the age links may be shuffled to reflect the updated LRU ordering. In this stage, the contents of each link with a relative age less than that of the referenced cache line is shifted into the next higher relative age. For example, in Table I if the cache line at relative age 5 is referenced, the contents of the age link for age 4 are shifted into the age link for age 5, the contents of the age link for age 3 are shifted into the age link for age 4, and the age link for age 3 is set at 0. It is noteworthy that the value contained in the bit pattern and not the bit pattern itself is shifted.

During the second stage of the update, the age links may be reset to reflect the update relative age. Each age link that indicates a relative age less than that of the referenced cache line may be incremented. Each age link that indicates a relative age equal to that of the referenced cache line may be set to 0, in reflection of the new most-recently-used position of the referenced cache line.

Table II depicts one example of the two stages of the update process. The 3 columns at left labeled “Before” depict the original state of the first 6 ways of the set. The columns labeled “Cache line” and “age” show the cache lines and their relative ages. The column labeled “age link” shows the original contents of the age links for the relative ages 3 through 6. In the Table II example, the cache line E is referenced. The columns labeled “stage 1” and “stage 2” show the contents of the age links after stage 1 and stage 2 of the update, respectively, have been completed.

TABLE II

| Before | | | Stage1 | Stage2 | |
|---|---|---|---|---|---|
| CacheLine | age | Age link | Age link | Age link | CacheLine |
| A | Age1 (000) | NA | NA | NA | E |
| B | Age2 (001) | NA | NA | NA | A |
| C | Age3 (010) | (0) | (0) | (1) | B |
| D | Age4 (011) | (01) | (00) | (01) | C |
| E (Ref) | Age5 (100) | (11) | (01) | (10) | D |
| F | Age6 (101) | (001) | (001) | (010) | F |

The correlation prefetcher 480 may be inhibited in prefetching by using the max-age replacement candidate predictor or expiration signature replacement candidate predictor as discussed above in connection with FIG. 3.

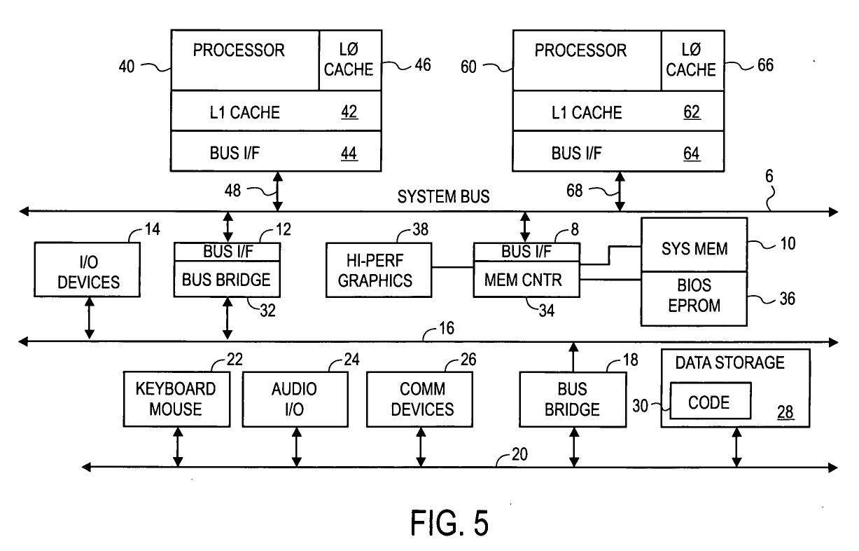

Referring now to FIG. 5, a schematic diagram of a processor system is shown, according to one embodiment of the present disclosure. The FIG. 5 system may include several processors of which only two, processors 40, 60 are shown for clarity. Processors 40, 60 may be the processor 100 of FIG. 1, including the branch outcome recycling circuit of FIG. 3. Processors 40, 60 may include L0 caches 46, 66 and L1 caches 42, 62. The FIG. 5 multiprocessor system may have several functions connected via bus interfaces 44, 64, 12, 8 with a system bus 6. In one embodiment, system bus 6 may be the front side bus (FSB) utilized with Pentium 4® class microprocessors manufactured by Intel® Corporation. A general name for a function connected via a bus interface with a system bus is an “agent”. Examples of agents are processors 40, 60, bus bridge 32, and memory controller 34. In some embodiments memory controller 34 and bus bridge 32 may collectively be referred to as a chipset. In some embodiments, functions of a chipset may be divided among physical chips differently than as shown in the FIG. 5 embodiment.

Memory controller 34 may permit processors 40, 60 to read and write from system memory 10 and from a basic input/output system (BIOS) erasable programmable read-only memory (EPROM) 36. In some embodiments BIOS EPROM 36 may utilize flash memory. Memory controller 34 may include a bus interface 8 to permit memory read and write data to be carried to and from bus agents on system bus 6. Memory controller 34 may also connect with a high-performance graphics circuit 38 across a high-performance graphics interface 39. In certain embodiments the high-performance graphics interface 39 may be an advanced graphics port AGP interface, or an AGP interface operating at multiple speeds such as 4×AGP or 8×AGP. Memory controller 34 may direct read data from system memory 10 to the high-performance graphics circuit 38 across high-performance graphics interface 39.

Bus bridge 32 may permit data exchanges between system bus 6 and bus 16, which may in some embodiments be a industry standard architecture (ISA) bus or a peripheral component interconnect (PCI) bus. There may be various input/output I/O devices 14 on the bus 16, including in some embodiments low performance graphics controllers, video controllers, and networking controllers. Another bus bridge 18 may in some embodiments be used to permit data exchanges between bus 16 and bus 20. Bus 20 may in some embodiments be a small computer system interface (SCSI) bus, an integrated drive electronics (IDE) bus, or a universal serial bus (USB) bus. Additional I/O devices may be connected with bus 20. These may include keyboard and cursor control devices 22, including mice, audio I/O 24, communications devices 26, including modems and network interfaces, and data storage devices 28. Software code 30 may be stored on data storage device 28. In some embodiments, data storage device 28 may be a fixed magnetic disk, a floppy disk drive, an optical disk drive, a magneto-optical disk drive, a magnetic tape, or non-volatile memory including flash memory.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

1. An apparatus, comprising:
a set in an n-way cache to have a max-age value;
a cache line in said set with an age; and
a max-age predictor to determine whether said cache line is referenced fewer times than a threshold value, and if so then to select said cache line for replacement.

2. The apparatus of claim 1, wherein said age is greater than said max-age value.

3. The apparatus of claim 1, wherein max-age predictor has a counter associated with said cache line.

4. The apparatus of claim 3, wherein said counter is saturating.

5. The apparatus of claim 3, wherein said counter decrements when said cache line is loaded.

6. The apparatus of claim 3, wherein said counter increments when said cache line is referenced.

7. An apparatus, comprising:
a first cache to hold a first cache line; and
a correlating prefetcher to prefetch a second cache line from a second cache when said correlating prefetcher determines that said second cache line is correlated with said first cache line.

8. The apparatus of claim 7, wherein said second cache is to store a plurality of intra-set links and said first cache is to store a copy of one of said plurality of intra-set links.

9. The apparatus of claim 8, wherein said correlating prefetcher determines that said second cache line is correlated with said first cache line when said copy of one of said plurality of intra-set links points at said second cache line.

10. The apparatus of claim 8, wherein said copy of one of said plurality of intra-set links is loaded into said first cache with said first cache line.

11. The apparatus of claim 7, wherein said second cache is to store a plurality of least-recently-used bits and said first cache is to store an age link derived from said plurality of least-recently-used bits.

12. The apparatus of claim 11, wherein said correlating prefetcher determines that said second cache line is correlated with said first cache line when said age link points at said second cache line.

13. A method, comprising:
setting a max-age value;
determining whether a cache line is likely to be referenced beyond said max-age value; and
selecting said cache line for replacement when said determining finds that said cache line is not likely to be referenced beyond said max-age value.

14. The method of claim 13, wherein said determining includes comparing a value of a counter for said cache line to a prediction threshold.

15. The method of claim 14, wherein said counter is incremented when said cache line is referenced at an age greater than said max-age value.

16. A method, comprising:
determining whether a correlation exists between a first cache line and a second cache line in a second cache;
loading said first cache line into a first cache; and
prefetching said second cache line to said first cache when said correlation exists.

17. The method of claim 16, wherein said determining includes preparing intra-set links in said second cache and transferring one of said intra-set links with said first cache line when said first cache line is loaded in said first cache.

18. The method of claim 17, wherein said determining further includes prefetching said second cache line when said one of said intra-set links demonstrates said second cache line is correlated with said first cache line.

19. The method of claim 16, wherein said determining includes preparing least-recently-used bits in said second cache and coupling an age link based upon said least-recently-used bits with said first cache line in said first cache.

20. The method of claim 19, wherein said determining further includes prefetching said second cache line when said age link demonstrates said second cache line is correlated with said first cache line.

21. An apparatus, comprising:
means for setting a max-age value;
means for determining whether a cache line is likely to be referenced beyond said max-age value; and
means for selecting said cache line for replacement when said determining finds that said cache line is not likely to be referenced beyond said max-age value.

22. The apparatus of claim 21, wherein said means for determining includes means for comparing a value of a counter for said cache line to a prediction threshold.

23. The apparatus of claim 22, wherein said counter is incremented when said cache line is referenced at an age greater than said max-age value.

24. An apparatus, comprising:
means for determining whether a correlation exists between a first cache line and a second cache line in a second cache;
loading said first cache line into a first cache; and
prefetching said second cache line to said first cache when said correlation exists.

25. The apparatus of claim 24, wherein said means for determining includes means for preparing intra-set links in said second cache and means for transferring one of said intra-set links with said first cache line when said first cache line is loaded in said first cache.

26. The apparatus of claim 25, wherein said means for determining further includes means for prefetching said second cache line when said one of said intra-set links demonstrates said second cache line is correlated with said first cache line.

27. The apparatus of claim 24, wherein said means for determining includes means for preparing least-recently-used bits in said second cache and means for coupling an age link based upon said least-recently-used bits with said first cache line in said first cache.

28. The method of claim 27, wherein said means for determining further includes means for prefetching said second cache line when said age link demonstrates said second cache line is correlated with said first cache line.

29. A system, comprising:
a processor including a set in an n-way cache to have a max-age value, a cache line in said set with an age, and a max-age predictor to determine whether said cache line is referenced fewer times than a threshold value, and if so then to select said cache line for replacement;
a bus to couple said processor to memory and to input/output devices; and
an audio input/output module.

30. The system of claim 29, wherein said age is greater than said max-age value.

31. The system of claim 29, wherein max-age predictor has a counter associated with said cache line.

32. The system of claim 31, wherein said counter increments when said cache line is referenced.

33. A system, comprising:
a processor including a first cache to hold a first cache line, and a correlating prefetcher to prefetch a second cache line from a second cache when said correlating prefetcher determines that said second cache line is correlated with said first cache line;
a bus to couple said processor to memory and to input/output devices; and
an audio input/output module.

34. The system of claim 33, wherein said second cache is coupled to said processor and is to store a plurality of intra-set links, and said first cache is to store a copy of one of said plurality of intra-set links.

35. The system of claim 34, wherein said correlating prefetcher determines that said second cache line is correlated with said first cache line when said copy of one of said plurality of intra-set links points at said second cache line.

36. The system of claim 35, wherein said copy of one of said plurality of intra-set links is loaded into said first cache with said first cache line.

37. The system of claim 33, wherein said second cache is coupled to said processor and is to store a plurality of least-recently-used bits, and said first cache is to store an age link derived from said plurality of least-recently-used bits.

38. The system of claim 37, wherein said correlating prefetcher determines that said second cache line is correlated with said first cache line when said age link points at said second cache line.
